(19) United States
(12) Patent Application Publication
(10) Pub. No.: US 2017/0369673 A1
(43) Pub. Date: Dec. 28, 2017

(54) FLAME RETARDANT POLYBUTYLENE SUCCINATE COMPOUND

(71) Applicant: PolyOne Corporation, Avon Lake, OH (US)

(72) Inventors: Chongfu ZHOU, Avon, OH (US); Roger W. AVAKIAN, Solon, OH (US)

(73) Assignee: PolyOne Corporation, Avon Lake, OH (US)

(21) Appl. No.: 15/537,862

(22) PCT Filed: Dec. 21, 2015
(86) PCT No.: PCT/US2015/067039

§ 371 Date: Jun. 19, 2017

Related U.S. Application Data
(60) Provisional application No. 62/096,012, filed on Dec. 23, 2014.

(51) Int. Cl. C08K 3/32; C08K 5/3492; C08K 9/04; C09K 21/10; C08L 67/02

(52) U.S. Cl. CPC C08K 3/32; C09K 21/10; C08L 67/02; C08K 9/04; C08K 5/34924; C08K 2003/323; C08L 2201/02

(57) ABSTRACT

Flame retardant polybutylene succinate (PBS) compounds using a non-halogenated intumescent flame retardant system are disclosed.

### CLAIM OF PRIORITY

This application claims priority from U.S. Provisional Patent Application Ser. No. 62/096,012 bearing Attorney Docket Number 12014030 and filed on Dec. 24, 2014, which is incorporated by reference.

### FIELD OF THE INVENTION

The present invention concerns a highly flame retardant polybutylene succinate (PBS) compound using non-halogenated ingredients for use in applications having stringent requirements for flammability, heat release, smoke and toxicity.

### BACKGROUND OF THE INVENTION

Thermoplastic compounds, unlike wood, metal, or glass, do not rot, rust, or shatter. For that reason, the world in the past seventy years has seen a revolution in material science arising from the combination of a thermoplastic resin and one or more functional additives to provide specific properties to the resin.

Unlike wood but like metal and glass, at a given temperature, a thermoplastic resin can melt. Its processing versatility benefits from its capacity to mix with the functional additives while in a molten state.

But in use, the exposure of a fully formed thermoplastic article to excessive heat or flame can be quite detrimental to property and person. Flame retardancy is a key attribute for many household items, for example hair dryers, curtains and drapes, water heaters and kitchen appliances. In addition, materials that are non-flammable and non-combustible are critical for many applications in industries, such as electronics, telecommunications, and transportation. Therefore, flame retardants, drip suppressants, mineral fillers, and char formers are frequently added as functional additives to help thermoplastic compounds retard the effects of heat or flame from melting or even burning.

Recently non-halogenated flame retardants have become popular because they minimize the release of halogenated chemicals if the plastic article would begin to degrade, melt, or burn. Polymers having non-halogenated flame retardants are particularly useful for enclosed areas, such as aircraft cabins, submarines, ships, subways and high rise buildings. However, polymer blends using non-halogenated flame retardants are often more difficult to process and have reduced physical and mechanical properties when compared to the original thermoplastic resin.

Currently very few polymer materials are available that can meet the high flammability standards required for use in aircraft interiors. Passing Level 4 Performance Criteria of FAR 25.853, which includes flammability, heat release rate, smoke and toxicity requirements, is particularly difficult.

### SUMMARY OF THE INVENTION

What the art needs is a non-halogenated polymer capable of meeting the more stringent standards for flammability, heat release rate, smoke and toxicity required for enclosed spaces.

The present invention has found a highly flame retardant polybutylene succinate (PBS) compound using a non-halogenated intumescent flame retardant system. One aspect of the invention is a flame retardant PBS compound having PBS, ammonium polyphosphate, a melamine compound as a synergist, a mineral filler, and optionally polytetrafluoroethylene (PTFE). The mineral filler can be quaternary ammonium salt modified montmorillonite, talc or a combination thereof. An inorganic heat stabilizer, such as Irganox™ B 225, optionally can be added for processing. In addition, an impact modifier optionally can be added for impact strength.

Another aspect of the invention is a flame retardant PBS compound used to make polymeric articles. Another aspect of the invention is a flame retardant PBS compound used to make polymeric articles via additive manufacturing for 3D printing. Rheology modifiers can be used to control the viscosity for the different processing conditions.

Features of the invention will be explored below.

### EMBODIMENTS OF THE INVENTION

Polybutylene Succinate

Polybutylene succinate (PBS) is a biodegradable aliphatic polyester that consists of polymerized units of butylene succinate, with repeating C₈H₁₂O₄ units shown below:

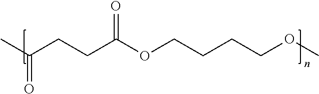

PBS has the CAS # of 67423-06-7. PBS is commercially available from several chemical manufacturers, including Samsung Fine Chemicals, Co. Ltd., Showa Denko K.K. and Mitsubishi Chemical.

Ammonium Polyphosphate

Ammonium polyphosphates are inorganic salts that are produced from the reaction of polyphosphoric acid and ammonia and has the chemical formula [NH₄PO₃]ₙ. Ammonium polyphosphates can be used as an intumescent flame retardant (FR) system. When exposed to heat or fire, ammonium polyphosphate will begin to decompose back to ammonia and phosphoric acid. The phosphoric acid acts as a catalyst in the dehydration of carbon-based poly-alcohols. The phosphoric acid reacts with such alcohol groups to form phosphate esters, which further decompose to release carbon dioxide. The release of non-flammable carbon dioxide, as well as nitrogen further degraded from ammonia and water, reduces the amount of available oxygen to the material that is burning. In contrast, halogen-based systems would result in the release of gases that contained halogens into the environment.

Ammonium polyphosphates are commercially available from several manufactures, including JLS Chemicals which offers JLS PNP1C, JLS PNP2V, and JLS PNP3D. Other commercial products are Clariant Exolit® AP, Amfine™ FP, Budenheim Budit™, Chitec Zuran®, and JJI JJAZZ™.

For the present invention, the flame retardant system can contain more than one type of ammonium polyphosphate.

Melamine Cyanurate

Melamine cyanurate, also known as melamine-cyanuric acid adduct or melamine-cyanuric acid complex, serves as a synergist for the ammonium polyphosphate. Melamine cyanurate is a crystalline complex formed from a 1:1 mixture of melamine and cyanuric acid and has a CAS No. of 37640-57-6 and a IUPAC name of 1,3,5-Triazine-2,4,6(1H,3H,5H)-trione, compd. with 1,3,5-triazine-2,4,6-triamine (1:1).

Quaternary Ammonium Salt Modified Montmorillonite

A mineral filler, quaternary ammonium salt modified montmorillonite is an organically modified nanoclay. Nanoclays are nanoparticles of layered mineral silicates are used to increase the strength, mechanical modulus and toughness of the polymer while improving barrier and flame retardant properties. Preferred for the present invention are nanoclays wherein 90% of the particles are less than 13 μm, and d spacing of about 18.5 Å.

Talc

Talc is used often in thermoplastic compounds as a mineral filler. Talc is a naturally occurring mineral, identified generally as a hydrous magnesium silicate having a Chemical Abstract Services Number of CAS #14807-96-6. Its formula is 3MgO.4SiO₂.H₂O.

In flame retardant thermoplastic compounds, talc can also assist in flame retardance by being a barrier to oxygen and increasing viscosity of the molten polymer matrix during combustion.

Talc is available from a number of commercial sources. Non-limiting examples of such talc useful in this invention are Jetfine®, Jetfil® brand talcs from Imerys Talc; Flextalc™ brand talcs from Specialty Minerals; and Talcron™ brand talcs from Mineral Technologies, Inc. Preferred for the present invention are ultra-fine, micronized talcs such as Jetfine® 3 CA, in which 50% of the particles are less than 1000 nm.

Optional Polytetrafluoroethylene

Polytetrafluoroethylene (PTFE) is known to be useful as a drip suppressant because it tends to shrink upon exposure to heat from a flame and hence retard dripping. PTFE can have a particle size ranging from about 5 μm to about 25 μm with the possibility of aggregation and agglomeration.

PTFE is commercially available from a number of manufacturers, but the best known is the Teflon™ brand from DuPont which invented the polymer.

Though PTFE is fluorinated, its presence in the compound is not regarded by those having skill in the art of flame retardant compounds as compromising the non-halogenated characteristics of the flame retardant itself because the amount of PTFE present is very minor. Therefore, the use of a fluorinated drip suppressant in the amounts identified in this invention does not disqualify the compound from being considered a non-halogenated flame retarded thermoplastic compound according to the course of conduct in the thermoplastic compound industry.

Additional Additives

A variety of additives known to those skilled in the art can be included in the flame retardant PBS compounds of the present invention to improve processing or performance properties.

The compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (elsevier.com website), can select from many different types of additives for inclusion into the compounds of the present invention.

Non-limiting examples of optional additives include adhesion promoters; biocides; anti-fogging agents; anti-static agents; anti-oxidants; bonding, blowing and foaming agents; dispersants; fillers and extenders; smoke suppressants; impact modifiers; initiators; lubricants; micas; pigments, colorants and dyes; plasticizers; processing aids; release agents; silanes, titanates and zirconates; slip agents, anti-blocking agents; stabilizers; stearates; ultraviolet light absorbers; viscosity regulators; waxes; catalyst deactivators, and combinations of them.

Optionally, epoxy-functional styrene-acrylic oligomers also can be added. These oligomers are functional additives having a variety of applications in polymer compositions, including improving chain extension, compatibilization, hydrolytic stabilization, and increased dispersion. A commercially available example of epoxy-functional styrene-acrylic oligomer is the Joncryl® product line manufactured by BASF.

Range of Ingredients

Table 1 shows acceptable, desirable and preferable ranges of ingredients useful in the present invention, all expressed in weight percent (wt. %) of the entire compound. The compound can comprise, consist essentially of, or consist of these ingredients. Any number between the ends of the ranges is also contemplated as an end of a range, such that all possible combinations are contemplated within the possibilities of Table 1 as candidate compounds for use in this invention.

TABLE 1

| Ingredient (Wt. %) | Acceptable | Desirable | Preferable |
|---|---|---|---|
| Polybutylene succinate | 45-70 | 59-70 | 50-52 |
| Ammonium polyphosphate | 15-30 | 24-30 | 30 |
| Quaternary ammonium salt | 0-5 | 0-5 | 0-3 |
| modified montmorillonite | | | |
| Melamine cyanurate | 0-5 | 4-5 | 5 |
| Optionally | 0-1 | 0-0.1 | 0-0.1 |
| polytetrafluoroethylene | | | |
| Talc | 0-5 | 0-5 | 0-5 |
| Optional additives | 0-15 | 0-10 | 0-7 |

Processing

The preparation of compounds of the present invention is uncomplicated. The compound of the present can be made in batch or continuous operations.

Mixing in a continuous process typically occurs in a single or twin screw extruder that is elevated to a temperature that is sufficient to melt the polymer matrix with addition of other ingredients either at the head of the extruder or downstream in the extruder. Extruder speeds can range from about 50 to about 500 revolutions per minute (rpm), and preferably from about 350 to about 450 rpm. Typically, the output from the extruder is pelletized for later extrusion or molding into polymeric articles.

Mixing in a batch process typically occurs in a Banbury mixer that is capable of operating at a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com website), one can make articles of any conceivable shape and appearance using compounds of the present invention.

### Usefulness of the Invention

The flame retardant compounds of the present invention can be shaped by extrusion, molding, calendering, thermoforming, additive manufacturing for 3-D printing, or other means of shaping into any plastic article usable in an interior or confined space where fire can cause personal injury or property damage. The compounds resist melting and dripping.

Literally any plastic article useful in a human-occupied space such as a building, a vehicle, or a tunnel can benefit from the flame retardancy of this polyurethane compound.

Flame retardant polymer articles are sold into the following markets: appliance, building and construction, consumer, electrical and electronic, healthcare, industrial, packaging, textiles, transportation, and wire and cable. Compounds of this invention can be used in any of those markets, but especially into the transportation market for aircraft interiors.

Examples provide data for evaluation of the unpredictability of this invention.

### EXAMPLES

Table 2 shows the list of ingredients. Table 3 shows the extrusion conditions. Table 4 shows the molding conditions. Table 5 shows the recipes and Tables 6A and 6B the test results. Properties of a typical flame retardant polymer compound of the invention are shown in Table 7.

TABLE 2

| Brand | Chemical | Purpose | Maker |
|---|---|---|---|
| PBS ENP01 | Polybutylene succinate | Polymer | Samsung Fine |
| G4560m | (CAS # 67423-06-7) | matrix | Chemicals Co., Ltd. |
| PBS ENP01 | Polybutylene succinate | Polymer | Samsung Fine |
| G4560J | (CAS # 67423-06-7) | matrix | Chemicals Co., Ltd. |
| JLS-APP | Ammonium | Flame | Hangzhou JLS |
| | polyphosphate | retardant | Flame Retardants |
| | | | Chemical Co., Ltd |
| FP2200 | Ammonium | Flame | Adeka |
| | polyphosphate | retardant | |
| JLS-MC25 | Melamine cyanurate | Non-halogen | Hangzhou JLS |
| | (CAS # 37640-57-6) | flame | Flame Retardants |
| | | retardant | Chemical Co., Ltd |
| Melapur ® | Melamine Cyanurate | Non-halogen | BASF |
| MC15 | (CAS # 37640-57-6) | flame | |
| | | retardant | |
| Cloisite ™ | Quaternary ammonium | Co-additive | Southern Clay |
| 30B | salt modified natural | | Products |
| | montmorillonite | | |
| | nanoclay | | |
| TEFLON ® | Polytetrafluoro- | Anti- | DuPont |
| 6C | ethylene | dripping | |
| | | agent | |
| Jetfine ® | Talc | Co-additive | Imerys Talc |
| 3CA | | | |
| Irganox ® | 50/50 blend of | Heat | Ciba |
| B225 | trisarylphosphite and | processing | |
| | sterically hindered | stabilizers | |
| | phenolic antioxidant | | |
| Joncryl ® | Epoxy-functional | Chain | BASF |
| 4368 | styrene-acrylic | extender | |
| | oligomer | | |

TABLE 3
Extruder Conditions

Extruder Type
18 mm Leistitz twin screw extruder

| | | |
|---|---|---|
| Examples | A-C, 1-2 | 3-4 |

| | |
|---|---|
| Order of Addition | All ingredients fed into the extruder |
| | hopper except APP, with APP added |
| | downstream. |

| | | |
|---|---|---|
| Zone 1 | 190° C. | 190° C. |
| Zone 2 | 190° C. | 190° C. |
| Zone 3 | 190° C. | 190° C. |
| Zone 4 | 190° C. | 190° C. |
| Zone 5 | 190° C. | 190° C. |
| Zone 6 | 190° C. | 190° C. |
| Zone 7 | 190° C. | 190° C. |
| Zone 8 | 190° C. | 190° C. |
| Main RPM | 500 | 350 |
| Side RPM | 209 | 209 |
| % load | 58 | 58 |
| Vacuum | On | On |

TABLE 4
Molding Conditions
Molding Machine: Nissei 88

| | | |
|---|---|---|
| Examples | A-C, 1-2 | 3-4 |

Drying Conditions before Molding:

| | | |
|---|---|---|
| Temperature (° C.) | 70 | 70 |
| Time (h) | 16 | 4 |

Temperatures:

| | | |
|---|---|---|
| Nozzle (° C.) | 210 | 200 |
| Zone 1 (° C.) | 204 | 193 |
| Zone 2 (° C.) | 199 | 188 |
| Zone 3 (° C.) | 199 | 188 |
| Mold (° C.) | 49 | 27 |

Speeds:

| | | |
|---|---|---|
| Screw RPM | 131 | 65 |
| Inj Vel Stg 1 | 20% | 60% |
| Inj Vel Stg 2 | 15% | 40% |
| Inj Vel Stg 3 | 10% | 40% |
| Inj Vel Stg 4 | 5% | 30% |
| Inj Vel Stg 5 | 5% | 20% |

Pressures:

| | | |
|---|---|---|
| Injection Pressure | 8 | 8 |
| Stg1 - Time (sec) | | |
| Injection Pressure 1 | 0 | 90% |
| Hold Pressure 2 | 90 | 25% |
| Hold Pressure 3 | 40 | 0 |
| Back Pressure | 5 | 5% |

Timers:

| | | |
|---|---|---|
| Injection Hold (sec) | 8 | 7 |
| Cooling Time (sec) | 15 | 20 |

Operation Settings:

| | | |
|---|---|---|
| Shot Size (mm) | 43 | 40 |
| Cushion (mm) | 1.1 | 1.1 |

TABLE 5

| Example | | | | | | |
|---|---|---|---|---|---|---|
| A | B | C | 1 | 2 | 3 | 4 |

Ingredients (by weight % of compound)

| | | | | | | | |
|---|---|---|---|---|---|---|---|
| Ultem ® 1000 | | 100.0 | | | | | |
| Ultem ® 9085 | | | 100.0 | | | | |
| PBS ENP01 G4560m | 100.0 | | | 69.9 | | 59.8 | 59.8 |
| PBS ENP01 G4560J | | | | | 69.9 | | |
| Irganox ® B225 | | | | 0.1 | 0.1 | 0.1 | 0.1 |
| FP2200 | | | | 24.2 | | | |
| JLS-APP | | | | | 24.2 | 29.2 | 29.2 |
| Melapur MC-15 | | | | 4.8 | | | |
| JLS-MC25 | | | | | 4.8 | 4.8 | 4.8 |
| Cloisite 30B | | | | 1.0 | 1.0 | | 5.0 |
| Jetfine ® 3CA | | | | | | 5.0 | |
| DuPont TEFLON 6C | | | | | | 0.1 | 0.1 |
| Joncryl 4368 | | | | | | 1.0 | 1.0 |
| Total | 100.0 | 100.0 | 100.0 | 100.0 | 100.0 | 100.0 | 100.0 |

Samples were tested according to the procedures and test standards described below.

HDT (ASTM D648): was measured on the Tinius Olsen HDT from Tinius Olsen Inc (PA, USA) at heating rate of 20° C./min. Two measurements were made for each sample.

Notched Izod Impact (ASTM D-256)

Cone calorimetry: The cone calorimeter was used to measure the heat release and smoke release of these formulations, according to ASTM E1354-13. A square sample of 100 cm×100 cm was placed horizontally 25 mm below the radiant heat source, the cone. The heat flux used was 65 kW/m². Upon exposure to the cone, a spark igniter was placed above the surface of the sample and the time to ignition is recorded. The time to flameout was also manually recorded, while the instrumentation measures the consumption of oxygen from the sample stream as well as the production of carbon monoxide and carbon dioxide. A laser placed across the exhaust duct measured the obstruction of the beam by the combustion products to output smoke measurements.

PCFC: The samples were tested with the MCC at 1° C./sec heating rate under nitrogen from 150° C. to 800° C. using method A of ASTM D7309 (pyrolysis under nitrogen). Each sample was run in triplicate to evaluate reproducibility of the flammability measurements.

TABLE 6A
Test Results

| Example | 3 | 4 |
|---|---|---|
| Flex Modulus (KSI @ 0.5 in/min) | 234 ± 7.9 | 246 ± 10.8 |
| Flex Strength (PSI @ 0.5 in/min) | 5576.8 ± 248.4 | 5888.7 ± 55.6 |
| Tensile Modulus (KSI) @ 2 in/min | 192.7 ± 29.1 | 283.4 ± 3.6 |
| Tensile Stength (PSI)@ 2 in/min | 3166.1 ± 147.3 | 3369.4 ± 27.8 |
| Tensile Strain at Break (%)@ 2 in/min | 19.5 ± 3 | 17.6 ± 1.6 |
| HDT @ 264 PSI | 56.9 ± 1.1 | 58.8 ± 1.1 |
| Notched IZOD (ft · lb/in) | 0.6 ± 0.03 | 0.47 ± 0.04 |
| Density (g/cm3) | 1.463 | 1.448 |
| UL-94 @⅛″ | V0 | V0 |

TABLE 6B
Additional Flammability Tests

| Example | | 1 | A | B | C |
|---|---|---|---|---|---|
| Cone | Average HRR | 160.7 | N/A | 101.7 | 119.1 |
| calorimetry | (KW/m2) | | | | |
| | Peak HRR | 217.8 | N/A | 251.2 | 150 |
| | (KW/m2) | | | | |
| | Total Smoke | 465.5 | N/A | 653.2 | 782.4 |
| | (m2/m2) | | | | |
| | Char Yield | 14.6 ± 0.2 | 0.3 ± 0.1 | 51.2 ± 0.5 | 41.6 ± 0.4 |
| | (wt %) | | | | |
| | HRR | 79 ± 56.6, | 545.1 ± 6.3 | | |
| | Peak(s)Value | 588 ± 49 | | 312.4 ± 4.8 | 202.7 ± 3.9 |
| | (W/g) | | | | |
| PCFC | HRR | 492.7 ± 1.2, | 427.3 ± 0.6 | | |
| | Peak(s)Temp(s) | 406 ± 1 | | 567.6 ± 2.3 | 516.4 ± 3.4 |
| | (° C.) | | | | |
| | Total HR (kJ/g) | 17.2 ± 0.9 | 20 ± 0.4 | 8.8 ± 0.1 | 10.9 ± 0.1 |

Properties of the flame retardant polymer compound of the present invention are shown in Table 7.

TABLE 7
Properties

| | | |
|---|---|---|
| Units | Test Methods | Value |

Physical

| | | | |
|---|---|---|---|
| Density | g/cm³ | ASTM D-792 | 1.46 |
| Tensile Modulus | GPa | ASTM D-638 | 1.3 |
| (2 in/min) | | | |
| Tensile Strength | Mpa | ASTM D-638 | 22 |
| (2 in/min) | | | |
| Tensile Elongation | % | ASTM D-638 | 19 |
| (2 in/min) | | | |
| Flexural Modulus | GPa | ASTM D-790 | 1.6 |
| (0.5 in/min) | | | |
| Flexural Strength (0.5 | MPa | ASTM D-790 | 38.5 |
| in/min) | | | |
| Heat Deflection | ° C. | ASTM D-648 | 57 |
| Temperature (264 psi) | | | |
| Notched Izod | J/m | ASTM D-256 | 32 |
| Flammability (3 mm) | | UL-94 | V0 |
| Glass Transition | ° C. | ASTM D3418 | 74 |
| Temperature via DSC | | | |
| Melting Temperature | ° C. | ASTM D3418 | 118 |
| via DSC | | | |
| Melt Flow Index | (g/10 min) | ASTM D1238 | 29.3 |
| 230° C./2.16 kg | | | |

Injection Molding - Processing
DRYING CONDITIONS

| | | |
|---|---|---|
| Drying temperature | ° C. | 80 |
| Drying time | hr | 4 |

MOLDING CONDITIONS

| | | |
|---|---|---|
| Melt temperature | ° C. | 185-200 |
| Barrel temperature | ° C. | 185-200 |
| Mold temperature | ° C. | 25-30 |
| Maximum moisture | % | 0.05 |
| content | | |

What is claimed is:

1. A flame retardant polymer compound, comprising:
(a) polybutylene succinate;
(b) ammonium polyphosphate;
(c) melamine cyanurate;
(d) mineral filler; and
(e) optionally, polytetrafluoroethylene;
wherein the mineral filler is a quaternary ammonium salt modified montmorillonite, talc, or a combination thereof.

2. The compound of claim 1, wherein the compound further comprises epoxy-functional styrene-acrylic oligomer as an optional additive.

3. The compound of claim 1, wherein the compound further comprises adhesion promoters; biocides; anti-fogging agents; anti-static agents; anti-oxidants; foaming agents; dispersants; fillers; smoke suppressants; impact modifiers; initiators; lubricants; colorants; plasticizers; processing aids; release agents; silanes; titanates; and zirconates; slip agents, anti-blocking agents; stabilizers; stearates; ultraviolet light absorbers; viscosity regulators; waxes; catalyst deactivators, and combinations of them.

4. The compound of claim 3, wherein ingredients of the compound have ranges of weight percents of the total compound as listed.

| Ingredient | Wt. % |
|---|---|
| Polybutylene succinate | 59-70 |
| Ammonium polyphosphate | 24-30 |
| Mineral filler | 1-5 |
| Melamine cyanurate | 4-5 |
| Optional polytetrafluoroethylene | 0-0.1. |

5. The compound of claim 3, wherein ingredients of the compound have ranges of weight percents of the total compound as listed.

| Ingredient | Wt. % |
|---|---|
| Polybutylene succinate | 50-52 |
| Ammonium polyphosphate | 30 |
| Mineral filler | 1-5 |
| Melamine cyanurate | 5 |
| Optional polytetrafluoroethylene | 0-0.1 |
| Other optional additives | 0-7. |

6. An article made from the flame retardant polymer compound of claim 1.

7. The article of claim 6 wherein the article is shaped by extrusion, molding, calendering, thermoforming, additive manufacturing for 3-D printing, or other means of shaping into a plastic article usable in an interior or confined space where fire can cause personal injury or property damage.

8. The article of claim 6, wherein the article is shaped by 3-D printing.

9. An article made from the flame retardant polymer compound of claim 2.

10. The article of claim 9 wherein the article is shaped by extrusion, molding, calendering, thermoforming, additive manufacturing for 3-D printing, or other means of shaping into a plastic article usable in an interior or confined space where fire can cause personal injury or property damage.

11. The article of claim 9, wherein the article is shaped by 3-D printing.

12. An article made from the flame retardant polymer compound of claim 3.

13. The article of claim 12 wherein the article is shaped by extrusion, molding, calendering, thermoforming, additive manufacturing for 3-D printing, or other means of shaping into a plastic article usable in an interior or confined space where fire can cause personal injury or property damage.

14. The article of claim 12, wherein the article is shaped by 3-D printing.

15. An article made from the flame retardant polymer compound of claim 4.

16. The article of claim 15 wherein the article is shaped by extrusion, molding, calendering, thermoforming, additive manufacturing for 3-D printing, or other means of shaping into a plastic article usable in an interior or confined space where fire can cause personal injury or property damage.

17. The article of claim 15, wherein the article is shaped by 3-D printing.

18. An article made from the flame retardant polymer compound of claim 5.

19. The article of claim 18 wherein the article is shaped by extrusion, molding, calendering, thermoforming, additive manufacturing for 3-D printing, or other means of shaping into a plastic article usable in an interior or confined space where fire can cause personal injury or property damage.

20. The article of claim 18, wherein the article is shaped by 3-D printing.
